(19) United States
(12) Patent Application Publication
(10) Pub. No.: US 2015/0199635 A1
(43) Pub. Date: Jul. 16, 2015

(54) METHOD AND A SYSTEM FOR DERIVING CHANGES IN OVERALL ALTERNATIVE PRIORITIES IN RESPONSE TO CHANGES IN ALTERNATIVE PRIORITIES WITH RESPECT TO OBJECTIVES

(71) Applicant: Ernest Forman, Boynton Beach, FL (US)

(72) Inventor: Ernest Forman, Boynton Beach, FL (US)

(73) Assignee: Ernest Forman, Boynton Beach, FL (US)

(21) Appl. No.: 14/155,915

(22) Filed: Jan. 15, 2014

(51) Int. Cl. G06Q 10/06

(52) U.S. Cl. CPC G06Q 10/06315

(57) ABSTRACT

A method and a system for deriving changes in overall alternative priorities based on changes in the priorities of alternatives with respect to objectives is provided. The method of the present invention includes the step of prioritizing the selected objectives to determine their relative importance to the user or users, prioritizing the selected alternatives with respect to the selected objectives to determine their relative performance to the user or users, synthesizing and producing a graphical presentation of the overall priorities of the alternatives and changing the priorities of alternatives with respect to the objectives in the synthesized graphical presentation resulting in changes to the overall priorities of the alternatives. The present invention would be used by manufacturing companies, service provider companies and government agencies in order to determine how they would improve their products or services.

### BACKGROUND OF THE INVENTION

1. Field of the Invention

The present invention generally relates to a method and a system for deriving changes in overall alternative priorities, and more particularly relates to a method and a system for deriving changes in overall alternative priorities in response to changes in alternative priorities with respect to objectives or criteria.

2. Description of Related Art

A wide variety of products and services (collectively referred to herein as “alternatives”) are available to humans. To make informed choices, users of the Internet need effective on-line tools to assist them in choosing or ranking alternatives or products with respect to the objectives of the user.

Decision makers are often puzzled when they have to choose among alternative solutions to a problem that requires multiple objectives or criteria to be considered, or when there may be a number of alternative solutions available, and the ultimate outcome may also be uncertain even after the final solution is chosen. In addition, producers of products or service providers may want to improve their product or service so that a decision maker would more likely choose their product.

A general method of decision making for obtaining the priorities and ranking of alternatives is performed by prioritizing the objectives and alternatives with respect to the objectives and then synthesizing the overall priorities of alternatives. The alternatives and the objectives are prioritized by using various methods such as pairwise comparisons, rating scales, utility curves, etc.

The term “pairwise comparison” generally refers to any process of comparing entities in pairs to judge which entity of the pair is more important or is preferred, or has a greater amount of some quantitative property, and by how much. The method of pairwise comparison is used in the scientific study of preferences, attitudes, voting systems, social choice, public choice, and multi-agent AI systems.

Various software systems are available to prioritize the alternatives with respect to the objectives as well as to prioritize the objectives. Some of these use the normalized values of a right hand eigenvector of a matrix of pairwise comparisons to derive priorities. An eigenvector of a square matrix A is a non-zero vector υ that, when the matrix is multiplied by υ, yields a constant multiple of υ, the multiplier being commonly denoted by λ. That is: Aυ=λυ (Because this equation uses post-multiplication by υ, it describes a right eigenvector.)

However, such system fails to provide a single page from where the priorities of alternatives with respect to objectives or criteria may be changed to obtain an overall change in the priorities of the alternatives. Therefore, there is a need of a system and a method for allowing changes of alternative priorities with respect to objectives and viewing corresponding changes in overall alternative priorities.

### SUMMARY OF THE INVENTION

In accordance with the teachings of the present invention, a method and a system for deriving changes in overall alternative priorities based on changes in the priorities of alternatives with respect to objectives, is provided.

An object of the present invention is to provide a method for deriving changes in overall alternative priorities based on changes in the priorities of alternatives with respect to objectives. The method includes the step of prioritizing the selected objectives to determine their relative importance to the user or users, prioritizing the selected alternatives with respect to the selected objectives to determine their relative performance to the user or users, synthesizing and producing a graphical presentation of the overall priorities of the alternatives and changing the priorities of alternatives with respect to the objectives in the synthesized graphical presentation resulting in changes to the overall priorities of the alternatives.

Another object of the present invention is to synthesize a graph having a combination of both line graph and bar graph. Further, the alternatives and the objectives are selected by the process of brainstorming by the one or more users.

Another object of the present invention is to prioritize the selected objectives by the analytic hierarchy process and to prioritize the objectives and selected alternatives with respect to the objectives by pairwise comparisons.

Another object of the present invention is to order the objectives by their priority and to observe the changes in overall alternative priority as the priority of alternative(s) are changed with respect to the ordered objectives.

An object of the present invention is to provide a system for deriving changes in overall alternative priorities based on changes in the priorities of alternatives with respect to objectives selected by a user. The system includes a memory unit and a processing device coupled to the memory unit, the processing device is configured to perform the steps of the method.

An object of the present invention is to allow a producer of a product or service provider to see how they might change the performance of their product or service with respect to one or more objectives so that consumers would find their product or service more preferable than competitive products or services.

Further features and advantages of the present invention, as well as the structure and operation of various embodiments of the present invention, are described in detail below with reference to the accompanying drawings.

### BRIEF DESCRIPTION OF DRAWINGS

FIG. 1 illustrates a flowchart of a method for deriving changes in overall alternative priorities based on changes in the priorities of alternatives with respect to objectives selected by a user;

FIG. 2 is a screenshot showing, by way of an Example, a Web Page showing the list of alternatives in accordance with an exemplary embodiment of the present invention;

FIG. 3 is a screenshot showing, by way of an Example, a Web Page showing the list of objectives in accordance with an exemplary embodiment of the present invention;

FIG. 4 is a screenshot showing, by way of an Example, a Web Page showing a pairwise comparison for determining the relative importance of two objectives in accordance with an exemplary embodiment of the present invention;

FIG. 5 is a screenshot showing, by way of an Example, a Web Page showing a pairwise comparison for determining the relative preference of two alternatives with respect to one of the selected objectives.

FIG. 6 is a screenshot showing, by way of an Example, a Web Page showing the relative importance of each objective and overall alternative priorities in accordance with an exemplary embodiment of the present invention;

FIG. 7 is a screenshot showing, by way of an Example, a Web Page showing a graphical presentation of prioritization of each alternative and overall alternatives with respect to the objectives;

FIG. 8 is a screenshot showing, by way of an Example, a Web Page for showing a graphical presentation of the overall alternative priorities by changing the priority of one alternative with respect to one objective; and

FIG. 9 is a schematic overview of the components in a network environment in accordance with another preferred embodiment of the present invention.

### DETAILED DESCRIPTION OF DRAWINGS

While this technology is illustrated and described in a preferred embodiment, a method and a system for deriving changes in overall alternative priorities based on changes in the priorities of alternatives with respect to objectives selected by a user may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

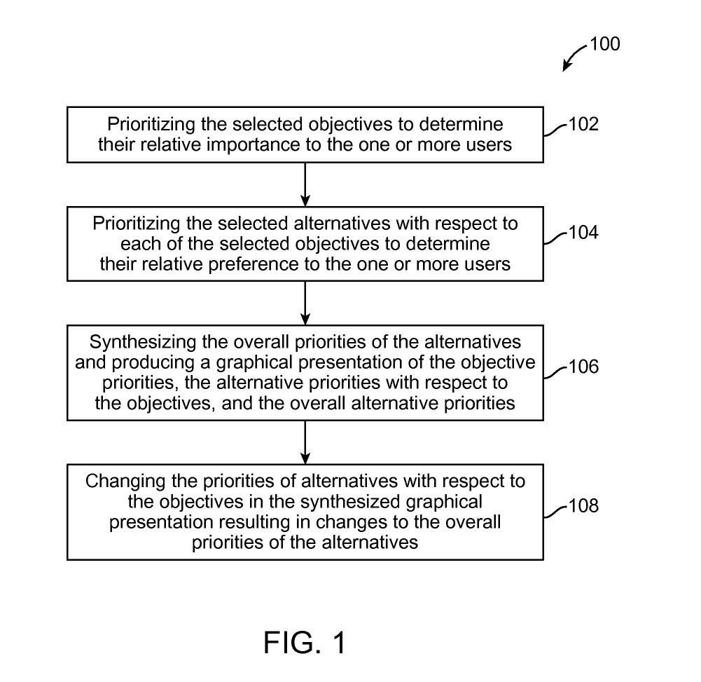

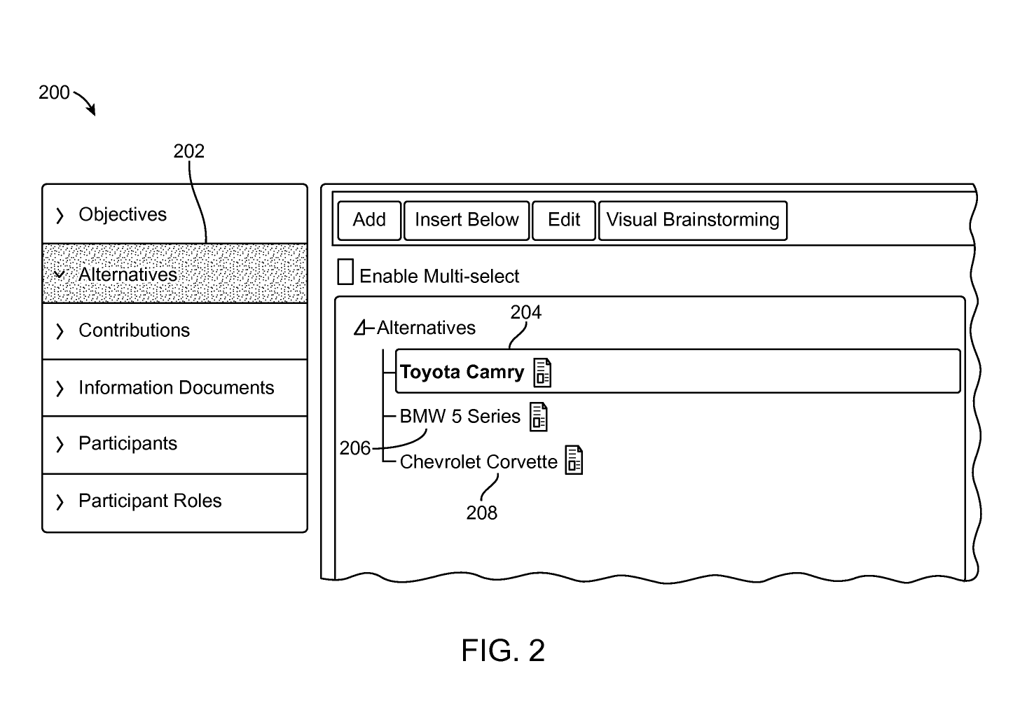

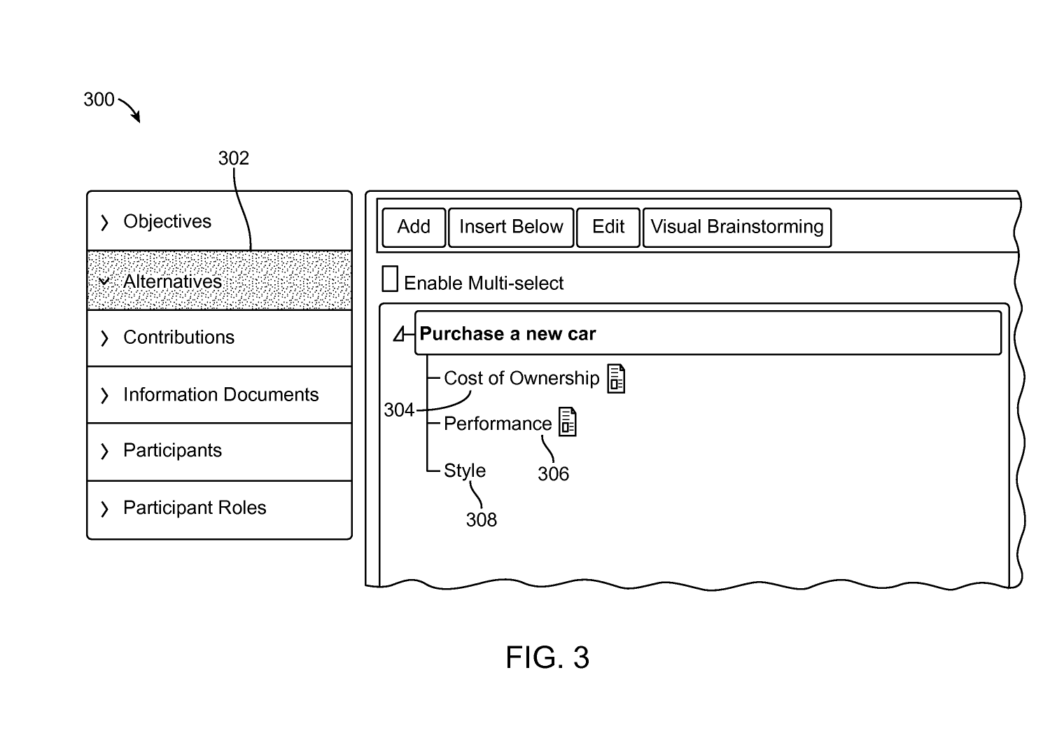

FIG. 1 illustrates a flowchart of a method 100 for deriving changes in overall alternative priorities based on changes in the priorities of selected alternatives with respect to objectives selected by a user. The user selects the objectives and alternatives depending upon their requirements, goals, company policies etc. Examples of selected objectives and alternatives are explained in detail in conjunction with FIG. 2 and FIG. 3 of the present invention.

Examples of alternatives include but are not limited to services, products, and situations etc. or in combination. Examples of objectives include but are not limited to qualities, features, conditions etc or in combination. However it will be readily apparent to those skilled in the art that various other types of objectives and alternatives may also be selected without deviating from the scope of the present invention.

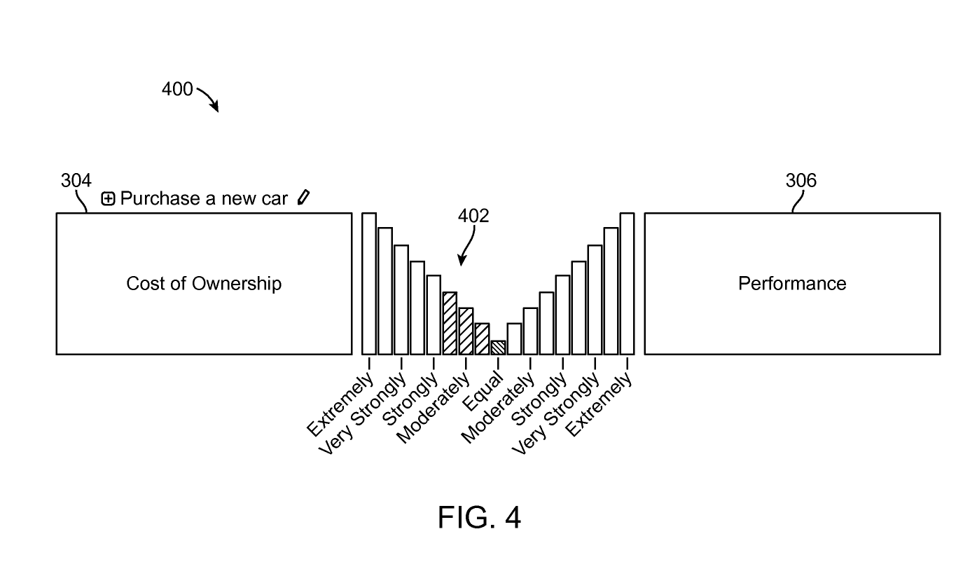

The method 100 initiates with a step 102 of prioritizing the selected objectives to determine their relative importance to the user or users. Each objective is prioritized to determine their importance by one or more users. The method of prioritization of objectives includes but not limited to pairwise comparisons, direct input, etc. as practiced in the analytic hierarchy process. An example of the prioritization of the selected objectives is explained in detail in conjunction with FIG. 4 of the present invention.

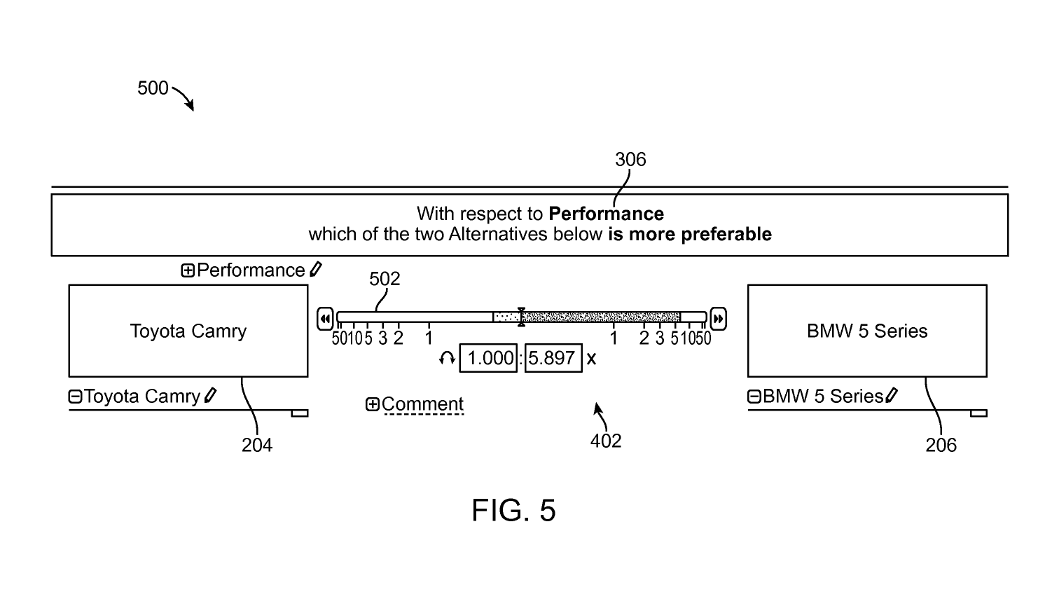

The step 102 is then followed by a step 104 of prioritizing the selected alternatives with respect to each of the selected objectives to determine their relative preference to one or more users. The method of prioritization of alternatives includes but not limited to pairwise comparisons, rating scales, utility curves and step functions etc. as practiced in the analytic hierarchy process. An example of the prioritization of the selected alternatives is explained in detail in conjunction with FIG. 5 of the present invention.

The step 104 is then followed by a step 106 of synthesizing the overall priorities of the alternatives and producing a graphical presentation of the objective priorities, the alternative priorities with respect to the objectives, and the overall alternative priorities. In a preferred embodiment of the present invention, the overall priorities of each alternative is obtained from the sum product of the objective priorities and the alternative priorities with respect to the objectives.

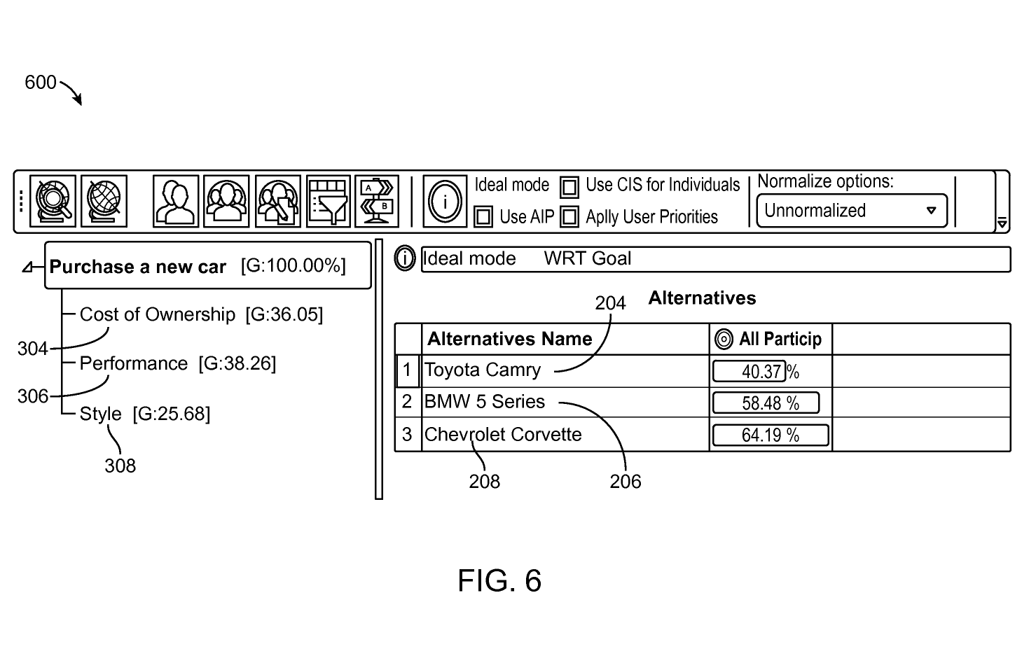

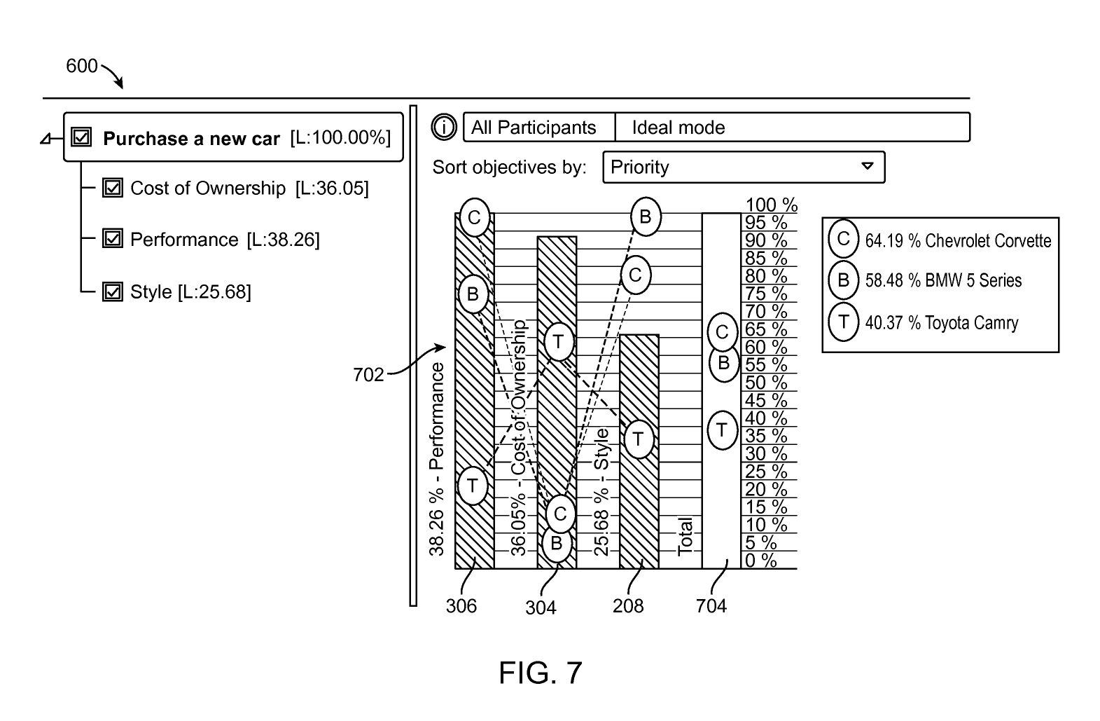

An example of the objective priorities and overall alternative priorities is shown and explained in detail in conjunction with FIG. 6. An example of the graphical presentation showing objective priorities, the priorities of each alternative with respect to each objective, and the overall alternative priorities is shown and explained in detail in conjunction with FIG. 7 of the present invention.

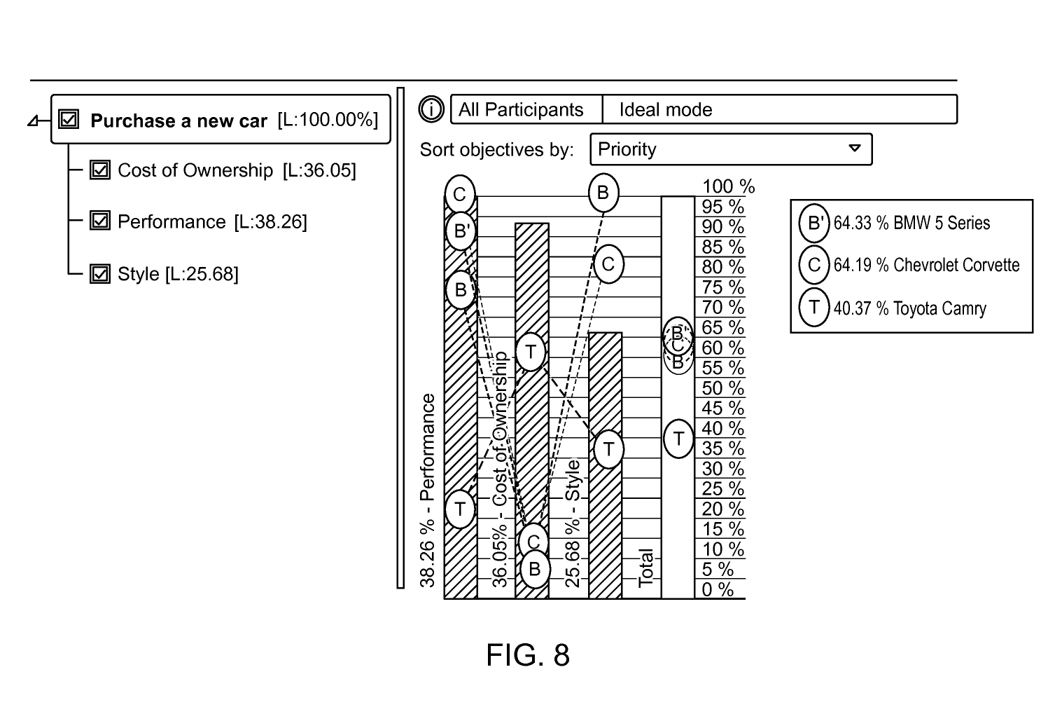

The step 106 is then followed by a step 108 of changing the priorities of one or more alternatives with respect to one or more of the objectives in the synthesized graphical presentation resulting in changes to the overall priorities of the alternatives. The graphical presentation allows the user to examine the change in the overall priorities while changing the priority of each alternative with respect to one or more objectives. An example of the graphical presentation showing change in overall priority with respect to the change in priority of each alternative for each objective is shown and explained in detail in conjunction with FIG. 8 of the present invention.

FIG. 2 is a screenshot showing, by way of an Example, a Web Page 200 showing the list of alternatives 202 in accordance with an exemplary embodiment of the present invention. In a preferred exemplary embodiment of the present invention, the user prepares a list of alternatives 202 for selecting a car. The alternatives 202 provided to the user are Toyota Camry 204, BMW 5 series 206 and Chevrolet Corvette 208. In a preferred embodiment of the present invention, the user is selecting a car depending upon the objectives set by the user. In a preferred embodiment of the present invention, the user selects the alternatives 202 by brainstorming, surveys, interviews, working groups, experiential knowledge, documented knowledge, risk trigger questions, lessons learned, output from risk-oriented analysis, historical information and engineering templates etc. However it will be readily apparent to those skilled in the art that various other methods for selecting alternatives 202 may also be envisioned without deviating from the scope of the present invention.

FIG. 3 is a screenshot showing, by way of an Example, a Web Page 300 showing the list of objectives 302 in accordance with an exemplary embodiment of the present invention. In a preferred exemplary embodiment of the present invention, the user prepares a list of objectives 302 for facilitating the user to decide on selecting a car. The objectives 302 selected are Cost of Ownership 304, Performance 306 and Style 308.

In a preferred embodiment of the present invention, the a user selects the objectives 302 by brainstorming, surveys, interviews, working groups, experiential knowledge, documented knowledge, risk trigger questions, lessons learned, output from risk-oriented analysis, historical information and engineering templates etc. However it will be readily apparent to those skilled in the art that various other methods for selecting objectives 302 may also be envisioned without deviating from the scope of the present invention.

FIG. 4 is a screenshot showing, by way of an Example, a Web Page 400 showing a pairwise comparison 402 for the prioritization of the objectives in accordance with an exemplary embodiment of the present invention. The Pairwise comparison generally refers to any process of comparing entities in pairs to judge which of each entity is more important and by how much.

For exemplary purposes as shown in FIG. 4, the objectives such as Cost of ownership 304 and Performance 306 are pairwise compared using the fundamental verbal scale of the analytic hierarchy process: Extremely, Very Strongly, Strongly, Moderately and Equal. However it would be known to those skilled in the art that various other scales may also be envisioned for pairwise comparison of objectives without deviating from the scope of the present invention. Similarly, a pairwise comparison is performed among the other objectives to indicate their relative importance to the user.

The set of pairwise comparisons are used to compute the objective priorities using the principle right hand eigenvector as is typically performed with the analytic hierarchy process. However it would be known to those skilled in the art that various other methods may be used for determining the relative importance of the objectives. The relative importance of each objective is shown and explained in detail in conjunction with FIG. 6 of the present invention.

FIG. 5 is a screenshot showing, by way of an Example, a Web Page 500 showing a graphical pairwise comparison 402 for the relative preference of two alternatives such as Toyota Camry 204 and BMW 5 Series 206 with respect to the objective such as Performance 306 in accordance with an exemplary embodiment of the present invention.

In a preferred embodiment of the present invention, the user pairwise compares the two alternatives with respect to the objective by using a ratio scale measure 502. For exemplary purposes, the ratio 504 provided for the pairwise comparison 402 to the two alternatives (Toyota Camry 204 and BMW 5 Series 206) is 1.000:5.897 with respect to the objective (Performance 306).

Similarly, a pairwise comparison is performed among the other alternatives to indicate their relative preference to the user. The set of pairwise comparisons are used to compute the alternative priorities using the principle right hand eigenvector as is typically performed with the analytic hierarchy process. However it would be known to those skilled in the art that various other methods may also be used for determining the relative preference of the alternatives. The relative preference of each alternative is shown and explained in detail in conjunction with FIG. 6 of the present invention

FIG. 6 is a screenshot showing, by way of an Example, a Web Page 600 showing the relative importance of each objective and relative preference of each alternative in accordance with an exemplary embodiment of the present invention. In a preferred embodiment of the present invention, the relative importance of each objective and each alternative is obtained from the pairwise comparison method.

For example, the pairwise comparison of the objectives provides relative importance of Performance 306 is 38.26%, Cost of Ownership 304 is 36.05% and Style 308 is 25.68%. Similarly for exemplary purposes, the pairwise comparison of each alternative with respect to each objective provides relative overall preference of the Toyota Camry 204 is 40.37%, BMW 5 Series 206 is 58.48% and Chevrolet Corvette 208 is 64.19%.

FIG. 7 is a screenshot showing, by way of an Example, a Web Page 700 showing a graphical representation 702 of prioritization of each alternative with respect to each objective and overall alternative priorities. Herein for exemplary purposes, ‘T’ indicates alternative Toyota Camry 204, ‘B’ indicates alternative BMW 5 Series 206 and ‘C’ indicates alternative Chevrolet Corvette 208.

The un-normalized priorities derived for the alternatives with respect to Performance 306 shows 100% for ‘C’, 76% for ‘B’ and 22% for ‘T’. Similarly, the priorities with respect to Cost of Ownership 304 are 62% for ‘T’, 10% for ‘B’ and 12% for ‘C; and priorities for Style 308 are 95% for ‘B’, 80% for ‘C’ and 30% for ‘T’. The overall priorities 704 for the alternatives are 64% (highest) for ‘C’, 58% for ‘B’ and 40% for ‘T.

FIG. 8 is a screenshot showing, by way of an Example, a Web Page 800 for showing a graphical presentation 802 for viewing a change in the overall priority 804 when a user manually changes the priorities of alternatives with respect to the objectives. Herein for exemplary purposes, ‘T’ indicates alternative Toyota Camry 204, ‘B’ indicates alternative BMW 5 Series 206 and ‘C’ indicates alternative Chevrolet Corvette 208.

With reference to FIG. 8, the priorities with respect to the Objective Performance 306 of ‘C’ and ‘T’ are the same as in FIG. 7, but the priority of ‘B’ has been increased from 76% (shown as a faded indicator) to B′ 90%. This one change results in changes in the overall alternative priorities where now ‘B’ is the highest priority. The change in overall alternative priorities is observed due to the change in the sum product of the objective priorities and the alternatives priorities with respect to the objectives including the alternative priority changes with respect to the objectives.

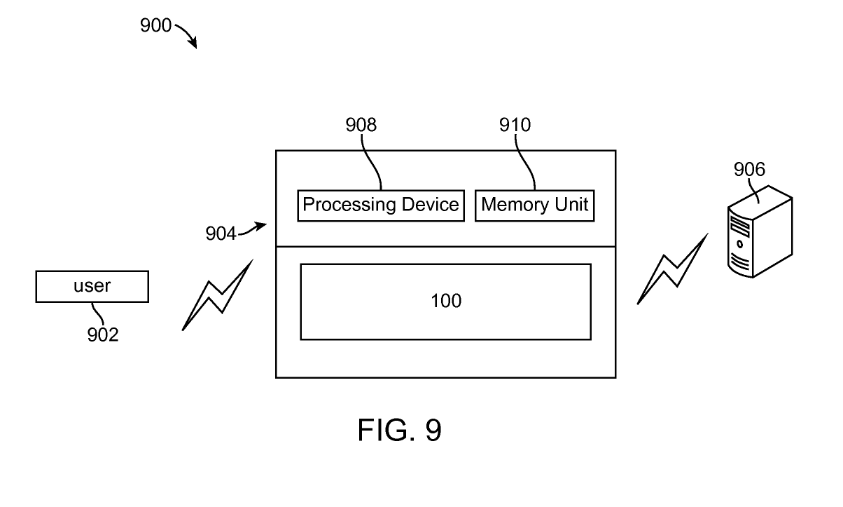

In another embodiment, the present invention may be implemented on virtually any type of computer regardless of the platform being used. FIG. 9 is a schematic overview of the components in a network environment 900. The network 900 includes a user 902, a system 904 and a communication network 906. The system 904 is operated by the user 902 and communicates through the communication network 906.

The system 904 includes a processing device 908 and a memory unit 910. The memory unit 910 stores and the processing device 908 execute the steps of the method 100. The method 100 is explained in detailed in conjunction with FIG. 1 to FIG. 8 of the present invention. Examples of the communication network 906 include but not limited to local area network (LAN) or a wide area network or internet etc. Further, those skilled in the art will appreciate that one or more elements of the system 900 may be located at a remote location and connected to the other elements over the communication network 906.

Examples of the system 904 include but not limited to a tablet pc, a laptop, a mobile phone using a Windows, DOS, Macintosh, UNIX or other operating system equipped with a standard web-browser application and capable of connecting to the Internet. It should be noted that the term ‘Internet’ is intended to encompass similar systems as well (i.e., World Wide Web or ‘www’) comprising the capability to communicate and access information through a network, telephone connections, ISDN connections, DSL connections, cable modem, etc.

The present invention should not be limited in its communication nomenclature. Exemplary operating systems include but are not limited to SymbianOS, Windows Mobile/Windows CE, Palm OS, Linux, Blackberry OS, BREW, webOS, Android, iOS, etc. which have been developed for mobile computing applications and can handle both data computing and communication applications, e.g., voice communications.

Examples of the processing device 908 includes but not limited to one or more special-purpose processing devices such as an application specific integrated circuit (ASIC), a field programmable gate array (FPGA), a digital signal processor (DSP), network processor etc. The processing device 908 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets.

The present invention offers various advantages such as providing a single graphical user interface page for changing priorities of alternatives with respect to objectives to observe change in the overall priorities. The present invention makes it convenient for the user to determine how they would change the preference of alternatives with respect to the objectives in order to achieve a desired change in the overall alternative priorities. The present invention would be used by manufacturing companies, service provider companies and government agencies in order to determine how they would improve their products or services.

The foregoing discussion discloses and describes merely exemplary embodiments of the present invention. One skilled in the art will readily recognize from such discussion and from the accompanying drawings that various changes, modifications and variations can be made therein without departing from the spirit and scope of the invention.

1. A method for deriving changes in overall alternative priorities based on changes in the priorities of alternatives with respect to objectives selected by one or more users, the method comprising the steps of:
prioritizing the selected objectives to determine their relative importance to one or more users;
prioritizing the selected alternatives with respect to each of the selected objectives to determine their relative preference to one or more users;
synthesizing to derive the overall priorities of the alternatives and producing a graphical presentation the objective priorities, the alternative priorities with respect to the objectives, and the overall priorities; and
changing the priority of one or more alternatives with respect to the one or more objectives in the synthesized graphical presentation resulting in deriving changes to the overall priorities of the alternatives.

2. The method according to claim 1 further comprising the step of brainstorming to select the alternatives and the objectives by the one or more users.

3. The method according to claim 1 wherein the selected objectives being prioritized by the analytical hierarchical process.

4. The method according to claim 1 wherein the selected alternatives being prioritized by the pairwise comparisons process.

5. The method according to claim 1 wherein the overall priorities being synthesized by using the synthesis mode.

6. The method according to claim 1 wherein the selected objectives being ordered in the lowest level of a hierarchy.

7. The method according to claim 1 wherein the graphical presentation comprises a combination of a line graph and a bar graph.

8. A system for deriving changes in overall alternative priorities based on changes in the priorities of alternatives with respect to objectives selected by one or more users, said system comprising:
a memory unit; and
a processing device coupled to said memory unit, said processing device configured to:
prioritize the selected objectives to determine their relative importance to the one or more users;
prioritize the selected alternatives with respect to each of the selected objectives to determine their relative preference to one or more users;
synthesize to derive the overall priorities of the alternatives and producing a graphical presentation the objective priorities, the alternative priorities with respect to the objectives, and the overall priorities; and
change the priorities of alternatives with respect to the objectives in the synthesized graphical presentation resulting in deriving change to the overall priorities of the alternatives.

9. The system according to claim 8 further comprising the step of brainstorming to select the alternatives and the objectives by the user.

10. The system according to claim 8 wherein the selected objectives being prioritized by the analytical hierarchical process.

11. The system according to claim 8 wherein the selected alternatives being prioritized by the pairwise comparisons process.

12. The system according to claim 8 wherein the overall priorities being synthesized by using either the synthesis mode.

13. The system according to claim 8 wherein the selected objectives being ordered in lowest level of hierarchy.
